(19) United States
(12) Patent Application Publication
(10) Pub. No.: US 2007/0113945 A1
(43) Pub. Date: May 24, 2007

(54) Run-flat system comprising self-inflating cells

(75) Inventors: Patrick Vervaet, Clermont-Ferrand (FR); Monique Boissonnet, Clermont-Ferrand (FR)

Correspondence Address: COHEN, PONTANI, LIEBERMAN & PAVANE, 551 FIFTH AVENUE, SUITE 1210, NEW YORK, NY, 10176, US

(73) Assignee: Michelin Recherche et Technique S.A., Granges-Paccot (CH)

(21) Appl. No.: 11/603,644

(22) Filed: Nov. 22, 2006

(30) Foreign Application Priority Data
Nov. 22, 2005 (FR) 05/11928

(51) Int. Cl. B32B 27/08; B60C 17/01

(52) U.S. Cl. 152/518; 428/35.7

(57) ABSTRACT

Closed cellular elements (1) intended for use on the inside of an assembly (E) formed of a wheel with a rim (J) provided with an inflation valve (V), on which is mounted a tire (P), the said cellular elements (1) having walls formed from thin, flexible sheets (11, 12) impermeable to gas. The cellular elements contain a given amount of a chemical composition which is solid or liquid at ambient temperature, but which changes to the gaseous state by phase change or by the shift of a chemical equilibrium between 40° C. and 80° C.

The invention concerns certain types of run-flat assemblies designed for fitting on automobile vehicles. These assemblies comprise a wheel rim with a valve and a tire mounted on the rim. According to the prior art relating to the production of such assemblies, the inside space between the inner wall of the tire and the rim is occupied by means designed to support the load temporarily when the pressure within the inside volume falls accidentally.

In the more precise context of the field of the invention, the said means can consist of a plurality of closed cells with flexible and gas-tight walls, whether elastic or not, containing a given quantity of gas which can if necessary be under pressure. These closed cellular elements, which form the same number of leakproof compartments, can be independent of one another or can be connected at their sides or ends to form strips or assemblies of given length comprising several closed cellular elements.

When the tire is inflated the cells are compressed and the pressure of the gases they contain equilibrates with the inflation pressure so that the volume of the cells occupies only a fraction of the inside volume of the tire.

In the event of pressure loss the cells expand and contribute towards equilibrating the load, at the cost of an increase in the sag of the tire. Only the cells in line with the puncture in the tread may perhaps be damaged, and the load is then distributed over the adjacent cells.

A first example of this type of application is described in the patent U.S. Pat. No. 3,256,123, in which elastic balls containing a gas under pressure are arranged within the inside space of the tire.

Another example of this type is disclosed in the patent DE 1 953 824, in which sections of flexible tubes with a given, non-extensible volume are made with the aid of an inelastic material. The wall of the tubes is formed of thermo-weldable, inelastic, thin sheets of polyvinyl chloride or polyurethane. The entire volume of each cell is filled with air at a given pressure, which is higher than atmospheric pressure. Strings of these tubes are arranged inside the volume between the inner wall of the tire and the wheel rim.

Depending on the nature of the materials used, it is also known to make leakproof joints between sheets of plastic or elastic materials, either by adhesive bonding as described in the publication U.S. Pat. No. 3,574,317 or by thermal welding as described in the publication U.S. Pat. No. 6,539,994.

Note, nevertheless, that in each of the variants described above, in the open air and under the full effect of the internal pressure of the gases they contain, the cells equilibrate their pressure with the atmospheric pressure. The said cells will then occupy a volume corresponding essentially to the volume they occupy when arranged in the inside space of an uninflated tire. The results of this are that special means have to be used to enable the said cells to be put into the inside volume of the tire, and that the volume of gas which can be introduced into the said cells is limited.

The purpose of the present invention is to propose a solution that overcomes these disadvantages.

To that end, it is proposed to make closed cellular elements with walls formed of thin, flexible, gas-tight sheets; each cellular element is filled with a given amount of a chemical composition which is solid or liquid at ambient temperature and which changes to the gaseous state by phase change or by displacement of a chemical equilibrium at a temperature higher than the ambient and generally between 40° C. and 80° C.

At ambient temperature the cellular elements occupy a small volume and it is easy to introduce a given number of the said cells into the inside space of the tire before completing the operation of mounting the tire on the wheel rim.

During rolling, the temperature inside the tire increases owing to the dissipation of heat that results from the movements of the tire. Above a certain threshold, this temperature increase triggers the chemical reaction that produces a gaseous compound that occupies the volume of the cellular element.

The choice of the temperature at which the chemical composition changes to the gaseous state, and consequently the determination of the nature and quantities of its components, depends on the conditions that enable the reaction to start. Too low a temperature would cause the reaction to start during ordinary industrial use, while too high a temperature would require considerable heat input difficult to achieve during normal running conditions of a vehicle. In practice a temperature 20° C. higher than the ambient temperature enables a response under most conditions of use.

The chemical reaction can be reversible or irreversible. In practice it will be noted that when the compound changes to the gaseous state, the pressure in the tire cavity increases. It is therefore necessary to adjust the pressure by increasing the quantity of air needed to obtain an equilibrium pressure equal to the service pressure of the tire.

Under these conditions a chemical composition is preferred whose change to the gaseous state is the result of an irreversible reaction. In effect, it is then possible to bring about the change of phase either when the tire is first used, or directly during the final phase of the mounting process, so that a stable utilisation pressure is maintained.

Thus, the decomposition by reaction of a mixture of sodium bicarbonate with citric acid adding to the formation of carbon dioxide gas is a good example of a chemical composition that enables the invention to be put into practice.

It is also possible to introduce a composition based on ammonium bicarbonate which decomposes into carbon dioxide at the desired temperatures but forms a reaction whose equilibrium varies with temperature.

The choice of compounds which volatilise within the temperature range desired, such as acetone, hexane, ethyl acetate or methylene chloride, can also be interesting but has the disadvantage that in the event of leakage there are severe environmental restrictions.

The amount of chemical compound that has to be introduced depends on the chemical compound itself and on the number of moles of gas it is desired to obtain in each of the cellular elements.

In a first embodiment the quantity of compound is adjusted such that the volume of all the cellular elements together after the chemical reaction or the composition's change of phase, and at the tire's service pressure and temperature, is equal to a fraction of the total inside volume delimited by the wheel rim and the inner surface of the tire.

In effect, it is not desirable that during normal running conditions the alveolar elements located radially on the outside are in contact with the inner wall of the tire. It is best for the bending undergone by the tire each time the wheel turns not to be transmitted to the alveolar elements, since this would result in elastic work by the walls of the said elements which would cause undesired heating and a disturbance of the thermal equilibrium of the system. In practice the volume fraction occupied is of the order or 40% to 70% of the total volume of the inside space of the tire, and is most preferably between 50% and 60% of the said total volume.

Under these conditions, during the use of the inflated tire the pressure of the gas contained in the cellular elements equilibrates with the pressure in the rest of the tire's inside space.

The choice of the nature of the material constituting the walls of the cellular elements is another determining factor for a system according to this first embodiment of the invention.

The choice of an elastic material enables cellular elements to be made whose volume can in principle increase without limit to equilibrate the internal pressure within the cellular elements with the pressure in the rest of the cavity. However, the fabrication of closed and perfectly leakproof cellular elements with this type of material generally entails the use of means that generate substantial amounts of heat. This source of heat can trigger the transformation reaction to the gaseous state of the chemical compounds previously introduced into the inside space of the cellular element. The result would be to reduce and in extreme cases eliminate the advantage aimed at, which is to bring about the reaction after the operation of mounting the tire on the rim. Moreover, in the event that a blunt object penetrates into the tire cavity, under certain conditions and owning to the extensibility of the walls, the partitions may come successively into contact with the indenter with the result that the walls of a large number of cells are perforated.

Thus it is preferable to choose an inelastic material when making a system according to the invention.

Into the inside space of the tire are introduced a number of cellular elements determined so that the volume formed by the sum of the maximum volumes of each cellular element is larger than the inside volume delimited by the wheel rim and the inner surface of the tire.

In this first embodiment, if the pressure in the space not occupied by the cellular elements falls accidentally, the gas contained in the said cellular elements will expand. Thus, the totality of the inside space of the tire is occupied by the cellular elements which then contribute towards supporting the load carried by the said tire. The equivalent service pressure is essentially equal to half the normal service pressure.

In another preferred embodiment of the invention, it is again chosen to make the walls of the cellular elements with an essentially inelastic material.

Into the inside space of the tire are introduced a number of cellular elements determined so that the volume formed by the sum of the maximum volumes of each cellular element corresponds to the desired fraction of the inside volume delimited by the wheel rim and the inner surface of the tire.

This provision entails filling the cellular elements with a quantity of chemical composition which, after the chemical reaction or the phase change of the compound, will produce a quantity of gas such that the pressure inside the cellular elements is higher than the normal service pressure of the tire. The cellular elements then expand to their maximum volume within the inner space formed by the wheel rim and the tire, and occupy the desired fraction of the volume of the said space. The volume fraction occupied is of the order of 50% to 60% of the total volume of the tire's inner space and is determined as a function of the amount of sagging that the tire can undergo in the event of flat running.

Note that in this configuration the system is less sensitive to pressure variations related to the reaction equilibrium of the chemical composition, since the volume occupied by the cellular elements is essentially constant.

Thus, by producing the gas that fills the cellular elements only after mounting the tire on the rim, it is possible to manipulate a large number of cellular elements occupying a small volume and to offer an advantageous solution to the problem concerning the introduction of closed cellular elements into the inner space of the tire. Before having interacted with a source of heat these cellular elements have the flexibility of use that stems from the nature of the material chosen for making their walls.

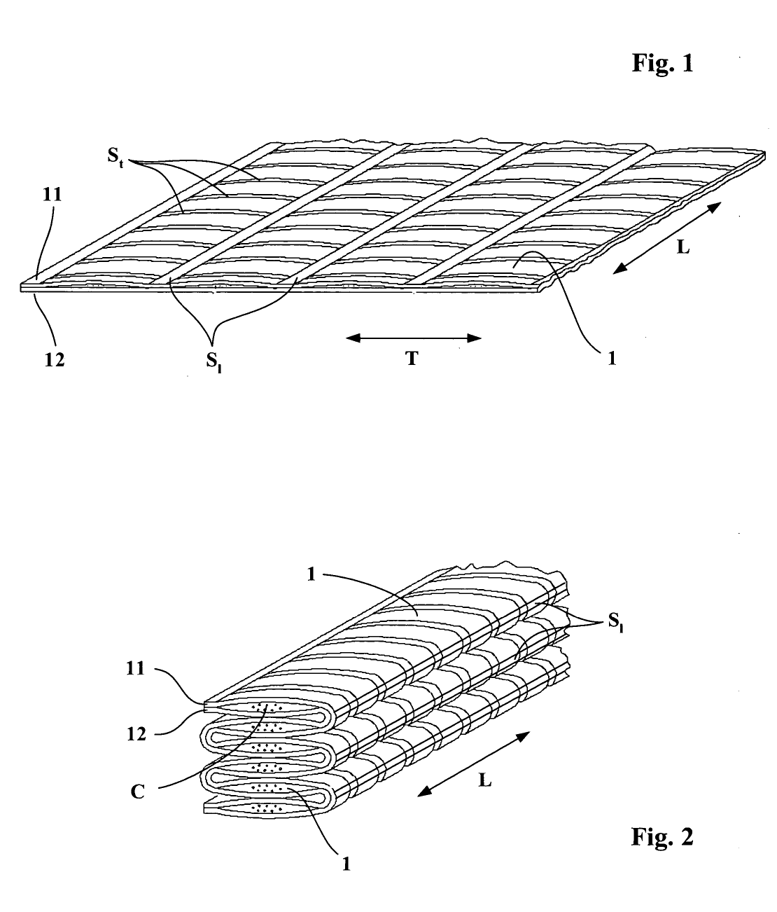

The description below illustrates practical examples of the implementation of the preferred embodiments of the invention, and refers to FIGS. 1 to 7 in which:

FIGS. 1 and 2 represent an embodiment of an assembly of cellular elements,

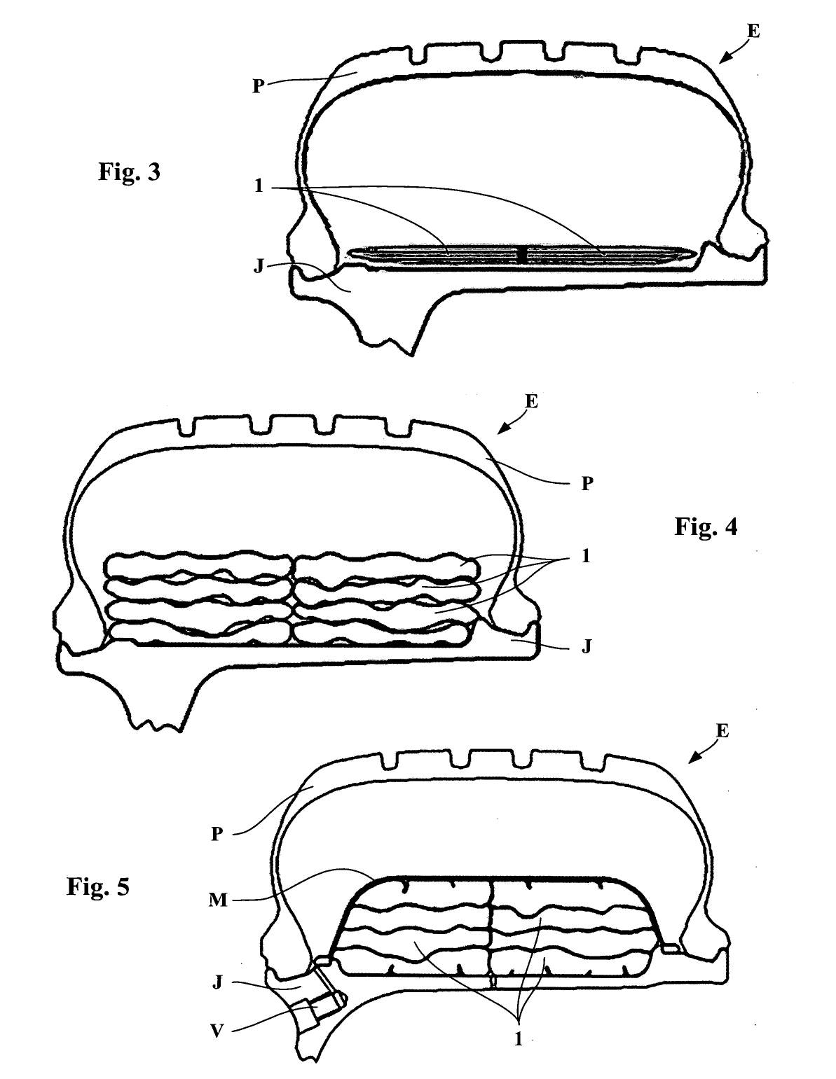

FIG. 3 shows a sectional view of an assembly containing a group of cellular elements before the pressurisation of the tire and the cellular elements it contains,

FIG. 4 shows a section view of an assembly containing a group of cellular elements after pressurisation of the tire and the cellular elements it contains, according to a first preferred embodiment of the invention,

FIG. 5 shows a sectional view of a variant embodiment in which the cellular elements are held by an elastic membrane,

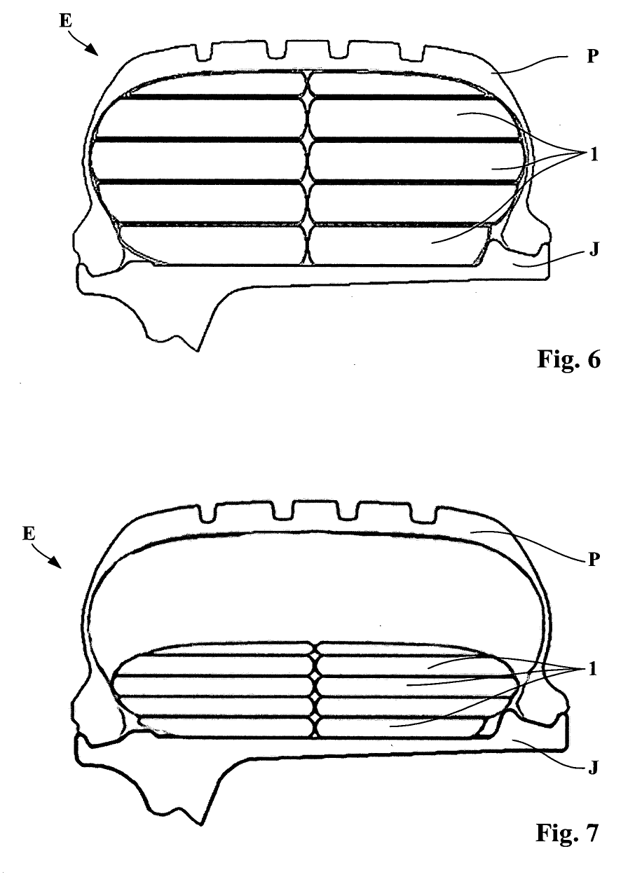

FIG. 6 shows a sectional view of an assembly according to the first preferred embodiment, at a reduced service pressure,

FIG. 7 shows a section view of an assembly containing a group of cellular elements after the tire and the cellular elements it contains have been pressurised, according to a second preferred embodiment of the invention.

The cellular elements 1 illustrated in FIG. 1 are formed from two sheets 11 and 12 which constitute the walls of the said cellular elements. The sheets 11 and 12 are made of a thin, flexible, gas-tight and essentially inelastic material, which can preferably be thermally welded.

Sheets formed from a stack of layers of the polypropylene/EVOH/polypropylene type or even the polypropylene/polyamide/EVOH/polyamide/polypropylene type have given good results. They can generally be thermally welded, which facilitates the production of cells on the industrial scale. Welding is carried out locally and gives off a negligible amount of heat insufficient to modify essentially the chemical equilibrium of the compound on the inside of the cellular element.

The sheets are welded together by longitudinal seams Sₗ and transverse seams Sₜ, the longitudinal and transverse directions being indicated respectively by the arrows L and T. A given amount of the chemical composition C is placed inside each cell before completing their closure. This produces an assembly of cellular elements juxtaposed with one another. Thanks to the low heat dissipation during welding, there is no risk of initiating the chemical reaction or phase change of the chemical composition during this operation.

The size of the cells, which is directly determined by the spacing of the weld seams, is chosen such that their unitary volume is very much smaller than the volume of the inner space of the tire P. This volume can range from a few cm³ to a few tens of cm³. Typically, good results have been obtained with cells whose volume is about 75 cm³, the longitudinal seams being spaced 8 cm apart and the transverse seams 4 cm apart for this. These values are given only indicatively, and smaller or larger dimensions can clearly be chosen, depending on the size of the tire in which it is desired to arrange the cellular elements.

The cellular elements could be detached from one another so as to obtain unitary cellular elements. However, it is found advantageous to make the assemblies of cellular elements by producing strips of a given width in the transverse direction and great length in the longitudinal direction. These very thin strips can be manipulated easily and are flexible enough to be rolled up on spools that can easily be stored and distributed.

The strips are cut into sections of given length as a function of the circumference of the wheel rim J and the tire P in which the said section is to be introduced. The section is rolled up inside the tire in one or more turns, taking care however that the length rolled at each turn corresponds to the circumference of the strip when the cellular elements expand under the effect of the formation of the gas and of any accidental pressure loss in the tire P, so that they can adopt the maximum volume they are intended to occupy. Thus, when the cells increase in volume, the layer of cellular elements arranged radially on the outside is intended to extend around a circumference essentially equal to the circumference of the inner part of the tire P located under the tread, while the layer located in contact with the rim J will remain essentially in the same position. Once the cellular elements have been arranged around the rim J, it is then possible to mount the tire P on the rim J as illustrated in FIG. 3.

An alternative to the implementation method described above consists in cutting from the continuous strip a section of length corresponding to the maximum circumference of the layer of cells located in the part radially closest to the tread when the cellular elements are at their maximum volume. The section is folded accordion-wise along the longitudinal weld seam Sₗ so as to obtain a section as wide as one or several cellular elements and comprising several layers arranged one above the other, as illustrated in FIG. 2. In the same way as before, this section is rolled up inside the tire, generally with only one turn. The two ends of the said section can also be thermally butt-welded together to form a ring of the desired circumference, which is placed on the rim J before fitting the tire P. Depending on the width of the rim J and the width of the ring, one or more rings of this type can be rolled on next to one another in the transverse direction.

To maintain the cohesion of these assemblies of layers formed of cellular elements, an elastic membrane M can be positioned over the last layer. As will be seen later, this membrane can be very useful for improving the holding of the said cellular elements during rolling.

The assembly E consisting of the tire P, the rim J and comprising the cellular elements arranged in the inside space between the rim J and the tire P can then be inflated to its service pressure via the inflation valve V. When the tire first becomes hot the chemical composition C in the cells transforms into a gas under the effect of heat input, and this expands the cellular elements until the pressure in the cells is in equilibrium with the inflation pressure or until the cellular elements occupy their maximum volume. Alternatively, provision can be made to heat the assembly E to a temperature at which the reaction or phase change of the chemical composition C is activated.

FIGS. 4, 5 and 6 illustrate the arrangement of the cellular elements in the first embodiment of the invention.

FIG. 4 shows the condition of an assembly E once the inside space has been raised to normal service pressure, when the pressure inside the cells is in equilibrium with the inflation pressure. For this it is necessary to adjust the inflation pressure after having produced the volume increase of the cellular elements in such manner that the cells only occupy a fraction of the inside space of the tire P.

By arranging a membrane M over the radially outer layer of the assembly of cellular elements as illustrated in FIG. 5, the holding in place of the cellular elements is ensured. The elasticity of the membrane can be adjusted so as also to counteract the centrifugal force when the assembly E rotates, while allowing the cellular elements to expand to their maximum volume if the assembly E loses pressure accidentally, as illustrated in FIG. 6.

The effects of the inflation pressure and the pressure exerted by the membrane on the cellular elements are combined, with the result that the pressure within the cellular elements is slightly increased. The quantity of chemical composition C must therefore be adjusted in such manner that the cellular elements occupy a space corresponding to the desired fraction of the inside volume of the tire under normal running conditions.

FIG. 7 illustrates the arrangement of the cellular elements in another preferred embodiment of the invention.

In this second case the pressure within the cellular elements is higher than the inflation pressure and once the chemical reaction or phase change of the compound C has taken place the cells occupy their maximum volume. The effect of this volume increase is to put the walls of the cellular elements under tension and to produce sufficient radial and circumferential rigidity in the assembly to make it unnecessary, also owing to the low weight of the walls in relation to their tensile strength, to have a membrane M in order to counteract the effects of centrifugal force.

If there is a pressure loss in the inside space, the tire sags and comes in contact against the surface of the radially outermost cellular elements. The cellular elements then behave like a support analogous to rigid supports such as that described, for example, in the patent EP 0 748 287.

The figures to which the description refers show an assembly E in which the bead seats are inclined outwards, as described in the patents cited above. However, the invention is not limited to this type of assembly and could just as well be implemented in an assembly comprising a tire mounted on rims inclined inwards.

1. Closed cellular elements (1) intended for use inside an assembly (E) formed of a wheel comprising a rim (J) provided with an inflation valve (V), on which is mounted a tire (P), the cellular elements (1) having walls formed from thin, flexible, gas-tight sheets (11, 12),
wherein the closed cellular elements enclose a given quantity of a chemical composition (C), which can be solid or liquid at ambient temperature but which changes to the gaseous state when heated to a temperature higher than the ambient temperature.

2. The cellular elements according to claim 1, in which the chemical composition (C) changes to the gaseous state at a temperature at least 20° C. higher than the ambient temperature.

3. The cellular elements according to claim 1, in which the chemical composition (C) changes to the gaseous state at a temperature between 40° C. and 80° C.

4. The cellular elements according claim 1, in which the chemical composition (C) changes to the gaseous state as the result of a phase change.

5. The cellular elements according claim 1, in which the chemical composition changes to the gaseous state as the result of the shift of a chemical equilibrium.

6. The cellular elements according to claim 5, in which the change of the chemical composition (C) to the gaseous state is essentially irreversible.

7. The cellular elements according claim 1, in which the chemical composition (C) comprises a mixture of sodium bicarbonate and citric acid.

8. The cellular elements according claim 1, in which the chemical composition (C) comprises ammonium bicarbonate.

9. The cellular elements according claim 1, in which the chemical composition (C) comprises one or more products chosen from a group consisting of acetone, hexane, ethyl acetate or methylene chloride.

10. The cellular elements according claim 1, in which the walls (11, 12) of the cellular elements (1) are formed of a material that can be thermally welded.

11. The cellular elements according to claim 10, formed from at least two sheets (11, 12) joined locally by linear weld seams arranged in the longitudinal direction (Sl) and in the transverse direction (St), which delimit an array of leakproof compartments (l) so as to form a flexible strip of small thickness.

12. The closed cellular elements according to claim 1, in which the walls (11, 12) of the cellular elements (1) are formed of an essentially inelastic material.

13. The closed cellular elements according to claim 1, in which the walls (11, 12) of the cellular elements (1) are formed of an elastic material.

14. An assembly (E) formed of a wheel rim (J) provided with an inflation valve (V), on which is mounted a tire (P),
wherein the assembly contains closed cellular elements (1) according to claim 12 arranged in the inside space delimited by the rim (J) and the tire (P).

15. The assembly (E) according to claim 14, in which the volume formed by the sum of the maximum volumes of each cellular element (1) is larger than the inside volume delimited by the rim (J) and the inner surface of the tire (P).

16. The assembly (E) according to claim 15, in which the quantity of chemical composition (C) is determined such that after the chemical reaction or phase change of the said chemical composition (C) leading to the formation of a given number of moles of gas, the total volume of the gas contained in the array of cellular elements (1) is equal, at the service pressure and temperature of the tire (P), to a fraction of the total inside volume delimited by the rim (J) and the inner surface of the tire (P).

17. The assembly (E) according to claim 14, in which the volume formed by the sum of the maximum volumes of each cellular element (1) corresponds to a fraction of the inside volume delimited by the rim (J) and the inner surface of the tire (P).

18. The assembly (E) according to claim 17, in which the quantity of chemical composition (C) is determined such that after the chemical reaction or phase change of the said chemical composition (C) leading to the formation of a given number of moles of gas, the pressure of the gas contained in the array of cellular elements is higher than the service pressure of the tire (P).

19. An assembly (E) formed of a wheel rim (J) provided with an inflation valve (V), on which is mounted a tire (P), wherein the assembly contains closed cellular elements (1) according to claim 13 arranged in the inside space formed by the rim (J) and the tire (P).

20. The assembly (E) according to claim 19, in which the quantity of chemical composition (C) is determined such that after the chemical reaction or phase change of the said chemical composition (C) leading to the formation of a given number of moles of gas, the total volume of the gas contained in the array of cellular elements (1) is equal, at the service pressure and temperature of the tire (P), to a fraction of the total inside volume delimited by the rim (J) and the inner surface of the tire (P).

21. The assembly (E) according claim 14, in which the cellular elements (1) are held by an elastic membrane (M) which exerts on the said elements a radial force directed towards the rim (J) that is large enough to counteract the effects of centrifugal force when the assembly (E) rotates, and which expands under the action of the extension of the cellular elements.

22. The assembly (E) according claim 14, in which the said cellular elements (1) have a unitary volume very much smaller than the inside volume delimited by the rim (J) and the inner surface of the tire (P).
